(19) United States
(12) Patent Application Publication
(10) Pub. No.: US 2019/0227573 A1
(43) Pub. Date: Jul. 25, 2019

(54) RE-SEARCH METHOD DURING UAV LANDING PROCESS

(71) Applicant: Stealth Air Corp, Bohemia, NY (US)

(72) Inventors: Nicholas Addonisio, Eastport, NY (US); Bryan Salvatore Monti, South Setauket, NY (US)

(21) Appl. No.: 16/338,200

(22) PCT Filed: Oct. 2, 2017
(86) PCT No.: PCT/US2017/054709

§ 371 Date: Mar. 29, 2019

Related U.S. Application Data
(60) Provisional application No. 62/402,163, filed on Sep. 30, 2016.

(51) Int. Cl. G05D 1/06; B64D 45/04; B64C 39/02; B64F 1/32

(52) U.S. Cl. CPC G05D 1/0676; B64D 45/04; B64C 2201/141; B64F 1/32; B64C 39/024

(57) ABSTRACT

An unmanned aerial vehicle (UAV) landing system is disclosed. The UAV landing system includes a memory; an imaging device; and a processor in communication with the memory and imaging device, wherein the processor is configured to: acquire, via the imaging device, a landing target; descend the UAV into a first zone associated with the landing target; determine if the landing target is within a field of view; and descend the UAV toward the landing target if the landing target is determined to be within the field of view.

### TECHNICAL FIELD

The present invention relates to unmanned vehicles, and more particularly to an unmanned vehicle that is configured to accurately and consistently land at a docking station.

### BACKGROUND

Unmanned Aerial Vehicles (“UAVs”) may use Global Positioning Systems (“GPS”) and Global Navigation Satellite System (“GNSS”) technology for primary navigation and position accuracy. Recreational GNSS technology generally yields position accuracy of 2-5 meters horizontally. Professional grade GNSS receivers can provide improved accuracy down to centimeter level accuracy with the use of real-time kinematic (“RTK”) supplemental technology and/or subscription based correction services. GNSS technology heavily relies on several conditions.

For instance, one condition includes satellite availability. The receiver should be capable of tracking many satellites (the more “channels”, the higher the confidence level of position data). Some receivers are capable of tracking satellites from multiple navigation constellations while others might be designed strictly to track one or more of the satellites of the available constellations.

A second condition includes clear/open skies. The receiver should theoretically achieve maximum performance with a clear and open view of the sky. Areas with heavy tree or building coverage (canopies, or urban canopies) make satellite acquisition and a 3D positional fix difficult to achieve.

A third condition includes adequate distance from obstructions and objects. GNSS receivers might be capable of receiving location data from satellites; however the proximity to nearby structures can prove to be devastating due to multi-path rejection. This is caused by signal reflecting off of structures, thus providing inaccurate position data.

To achieve consistent and accurate position data while landing can prove to be difficult or impossible depending on the quality of GNSS data and whether or not GNSS data is denied in the environment. Unstable location data can prove to be catastrophic for an autopilot which relies heavily on GNSS only data or GNSS data combined with inertial sensor data because a crash is imminent.

### SUMMARY

The present disclosure is at least directed to a process by which accurate and consistent landings by a UAV are possible. The intended use of the technology is to outline a process by which unmanned aerial vehicles can achieve a “precision landing”. A “precision landing” can be described as landing or docking by a UAV with improved accuracy performance over that of conventional GPS and GNSS technology. The process allows an aircraft with VTOL (“Vertical Take-Off and Lift”) capability to land with improved position accuracy by use of a stand-alone visual tracking system or a hybrid system that combines inertial sensors, GNSS, and a visual tracking system. This concept describes a process by which accurate and consistent landings are possible.

According to an aspect of the present disclosure, an unmanned aerial vehicle (UAV) landing system, comprises memory; an imaging device; and a processor in communication with the memory and imaging device, wherein the processor is configured to: acquire, via the imaging device, a landing target; descend the UAV into a first zone associated with the landing target; determine if the landing target is within a field of view; and descend the UAV toward the landing target if the landing target is determined to be within the field of view.

According to another aspect of the present disclosure, an unmanned aerial vehicle (UAV) landing system, comprises memory; an imaging device; and a processor in communication with the memory and imaging device, wherein the processor is configured to: acquire via the imaging device a landing target; descend the UAV into a first zone associated with the landing target; determine if the landing target is within a field of view; and descend the UAV toward a second zone associated with the landing target if the landing target is determined to be within the field of view.

According to yet another aspect of the present disclosure, an unmanned aerial vehicle (UAV) landing method, comprises acquiring, using a processor, a landing target; descending the UAV, using the processor, into a first zone associated with the landing target; determining, using the processor, if the landing target is within a field of view; and descending the UAV, using the processor, toward a second zone associated with the landing target if the landing target is determined to be within the field of view.

### BRIEF DESCRIPTION OF THE DRAWINGS

FIG. 1 is a block diagram of the system in accordance with aspects of the present disclosure.

FIG. 2 is a diagram illustrating the altitude-based decision process in accordance with aspects of the present disclosure.

FIG. 3 is a flowchart illustrating the landing process in accordance with aspects of the present disclosure.

FIG. 4 is a diagram illustrating field of view based target areas in accordance with aspects of the present disclosure.

FIG. 5 is a diagram illustrating field of view tolerance boxes overlaying an actual landing target in accordance with aspects of the present disclosure.

FIG. 6 is a diagram illustrating field of view tolerance boxes overlaying an actual landing target in accordance with aspects of the present disclosure.

FIG. 7 is a diagram illustrating a view from a landing pad in a situation where the target acquisition and calculations are performed on the ground station and not on the UAV itself in accordance with aspects of the present disclosure.

### DETAILED DESCRIPTION

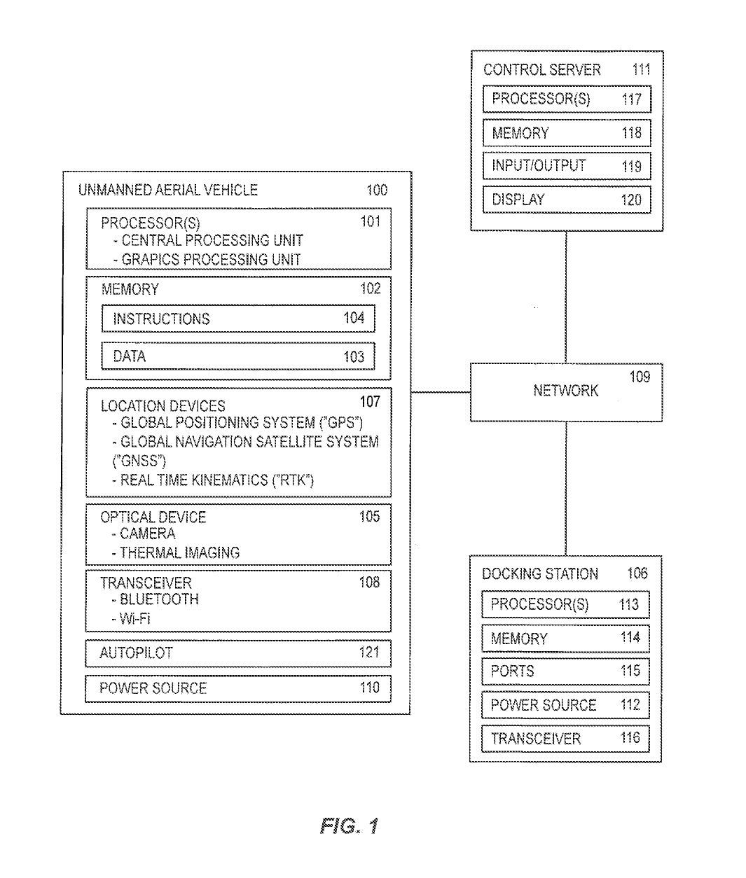

As illustrated in FIG. 1, an Unmanned Aerial Vehicle (UAV) 100 disclosed herein includes a processor 101 that is in communication with a memory 102. The memory 102 may store, for example, data 103 and executable instructions 104 by the processor 101. As one example, the processor 101 may be a Central Processing Unit (“CPU”). Furthermore, the processor 101 may be in communication with a Graphics Processing Unit (“GPU”) that processes images that are captured by an optical device 105, such as a camera, video camera, etc. The optical device 105 may include its own processor or specially programmed microcontroller to capture images, and is positioned on the UAV 100. Alternatively, the processor 101 may be capable of processing the images captured by the optical device 105 on its own, without the use of an on-board GPU. The UAV 100 may also include as one or more optical device 105 a thermal imaging device that is capable of detecting heat transmitters, which may be used to locate a particular location, such as a docking station 106 illustrated in FIG. 1.

The UAV 100 may include various location devices 107 that help identify the positioning of the UAV 100, The location device may include one or more of a GPS, a GNSS receiver, or an RTK system. The UAV 100 may alternatively or in addition use Wi-Fi or Bluetooth™ capabilities via transceiver 108 to identify its location relative to a modem, Wi-Fi extender, etc. Furthermore, the transceiver 108 via may be utilized to transmit data over a network 109 or between devices, such as over a Personal Area Network (“PAN”), Local Area Network (“LAN”) or Wide Area Network (“WAN”), as depicted in FIG. 1. The UAV 100 includes a power source 110 such as a battery, lithium battery, etc.

An autopilot 121 is also included in UAV 100. One example of the autopilot 121 is the Pixhawk Autopilot. The autopilot 121 controls the overall flight control of the UAV 100 during unmanned flight. The autopilot 121 provides general autonomous control of the UAV during normal flight and during landing as described herein.

FIG. 1 illustrates the UAV 100 in communication with the docking station 106 and also a control server 111 over the network 109 via a transceiver 116. In this regard, although the UAV 100 and docking station 106 may each be able to connect via transceiver 116, the two devices may alternatively connect to each other via physical connectors or ports 115. For instance, the UAV 100 may land on the docking station 106 in a manner that will allow the docking station 106 to charge the UAV 100 by transferring power. In this regard, the docking station 106 may be connected to a stable power source 112 that allows the docking station 106 to continuously receive power, such as an outlet that connects to an electrical grid, or an organic means such as solar panels. In addition, the docking station 106 and UAV 100 may transmit data to each other via Bluetooth™ or via a physical data connection. In this regard, the docking station 106 may likewise include a processor 113 and memory 114 to process received data.

The UAV 100 and the docking station 106 may also communicate with the control server 111 over the network 109. The control server 111 may be the central hub that the UAV 100 and docking station 106 transmit data to for storage and processing. The control server 111 can include one or more processors 117, memory 118, input/out devices 119, and/or a display 120. In this regard, although FIG. 1 only shows a single UAV 100 and docking station 106, it should be understood that there may be plurality of UAVs 100 and docking stations 106 that are capable of communicating with each other. Furthermore, the UAV 100 depicted in FIG. 1 may be capable of connecting to, landing on, and communicating with multiple docking stations 106, and the docking station 106 depicted in FIG. 1 may likewise be capable of connecting to, charging, and communicating with multiple UAVs 100.

For the purpose of docking or landing with precision, the introduction of a visual landing system may be preferred. A visual landing system can involve an illuminated or non-illuminated source (or target) that the UAV 100 would “look” for in its landing/descent phase. While such a system is relatively new to the UAV industry, the landing accuracy and consistency required for such a precision landing must be improved.

In general, one proposed method of landing involves a process that can be summarized to perform one or more of the following method steps:

1. during the descent phase of the mission, the UAV 100 begins to look for a visual target on the docking station 106;

2. during the landing/descent phase, the UAV 100 is using location devices 107 internally or externally mounted relative to the autopilot controller 121, GNSS, and the optical device 105 (e.g., a camera, thermal imager, or other optical sensor);

3. the UAV 100 descends and calculates the required movement estimate relative to the visual target (example: if the UAV detects the target in front of itself, it must command a forward movement);

4. the UAV 100 descends again, processes the images taken of the visual target in the field of view of the optical device 105 and commands movements until UAV 100 is positioned directly over the target;

5. the UAV 100 continues this process until it lands on the desired area;

6. in the event that the optical device 105 or visual processing software does not detect the visual target in the field of view, the UAV 100 ascends or moves horizontally in attempt to re-acquire the target within its field of view;

7. the UAV 100 may or may not see the target on its first attempt to establish an improved position and so UAV 100 must continue to ascend and move horizontally as pre-programmed in order to seek target identification;

8. eventually, due to an increase in altitude, the optical device 105 shall identify the target due to an increasing field of view; and/or

9. at the time of reacquisition, the UAV 100 shall continue its regular landing routine for final landing.

As a further example and as discussed in further detail below, the UAV 100 may descend into one or more zones the closer the UAV 100 nears the docking station 106. Thus, in a first zone ZONE 1, which is furthest from the target, the UAV 100 may continue to descend into a second zone ZONE 2 toward the target, or alternatively ascend if the target or docking station 106 is not within the proper field of view of the UAV 100. At every zone into which the UAV 100 descends, or alternatively just the docking station 106, the UAV 100 may descend if the UAV 100 determines that the docking station 106 is still within a threshold field of view of the UAV 100. Alternatively, the UAV 100 will ascend to a more distant zone to re-acquire the target.

As an additional example, the UAV 100 may ascend or otherwise temporarily abort the landing process for multiple reasons, in addition to the scenario where the docking station 106 is outside an appropriate threshold field of view or distance from the UAV 100. For instance, if wind speeds increase, the UAV 100 may choose to either stop descending to save resources to combat the wind, or to alternatively ascend and restart the process altogether. Other environmental reasons may cause the UAV 100 to pause its descent, ascend, or abort altogether, such as rainfall, snow, hail, tornado, etc. Furthermore, if the docking station 106 is in a condition where the UAV 100 cannot land, the UAV 100 may need to ascend or abort the landing as well, such as a branch falls on the docking station 106, leaves cover the connecting ports thereon, or if the docking station 106 is tilted or off-balance, such as due to heavy winds or other type of intervention. As another example, if the UAV 100 loses connection with the docking station 106, such as the Bluetooth or Wi-Fi signal drops below a predetermined threshold, then the UAV 100 may decide to pause the descent, or ascend.

As a further example, in the event that the landing target cannot be acquired or processed appropriately, such as for the reasons discussed above, the UAV 100 may abort the precision landing. In this regard, the UAV 100 may land in a designated safe zone where precision accuracy is not a concern due to a safe lateral space/distance from the landing site.

The process describes the virtual “funnel” area whereby the UAV 100 descends and continually gets closer to the target. The proposed method of commanding actions to re-search the area by increasing altitude and/or moving horizontally dramatically increases the chances of a successful target identification.

One benefit of this process is that it allows for commercial or mission critical applications that require the docking or landing of UAVs to operate with a high level of accuracy. Despite wind conditions, negative environmental factors, or existing technology performance flaws, this process allows a UAV to have multiple chances to successfully dock or land. This method also prevents the landing of a vehicle in an unintended area.

Furthermore, the method prevents a UAV from lingering at low altitude where it can avoid several catastrophic situations. First, the vehicle may become more susceptible to multi-path GNSS interference due to remaining at low relative altitude where such interference can be observed, such as for example next to a building. Second, catastrophic low battery failure can occur if the UAV is not commanded to take further action when its target is not observed due to the volatility of electric lithium polymer batteries (if the vehicle operates on an electric power system). In the event that the UAV has “drifted” too far outside of its optical equipment field of view, the UAV now has a process to correct itself and not continue “looking” or processing images or video that otherwise will not display the target.

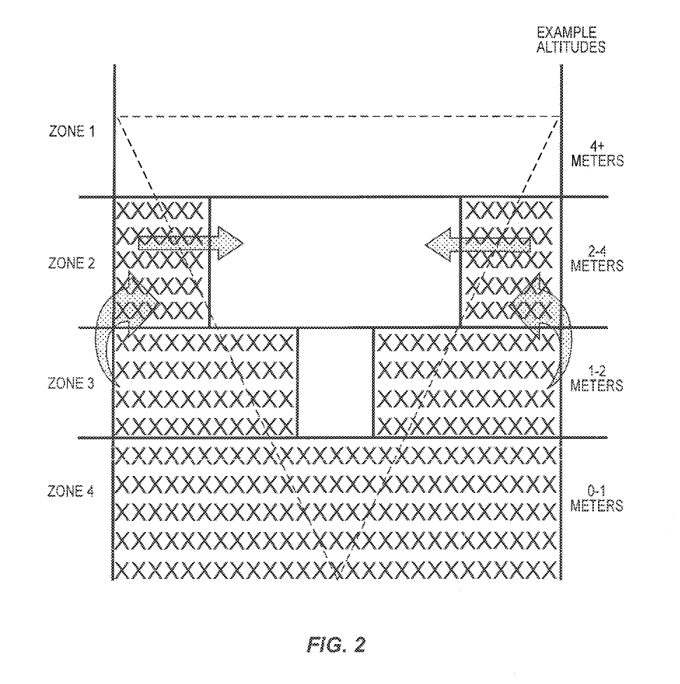

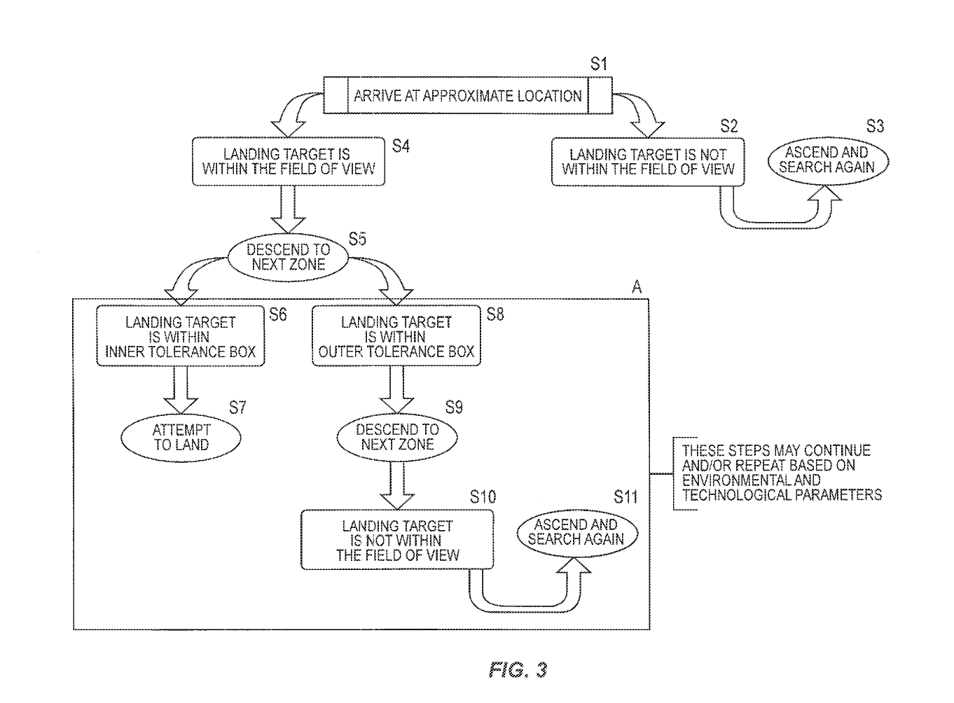

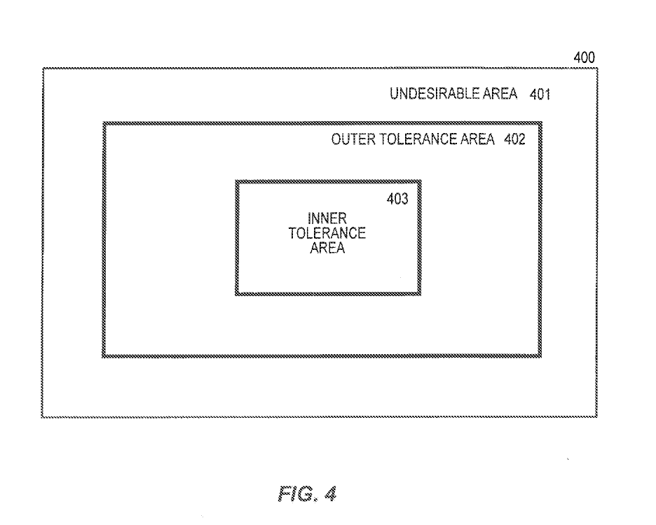

The process of a landing procedure may be defined appropriately by the following illustrations. In FIG. 2, the “X” symbols denote non-desirable position areas. The UAV will determine if it is in a non-desirable position area based on its landing target in relation to the field of view of its landing camera or sensor. FIG. 3 illustrates a process by which a camera vision, or similar application, might dictate if the landing target is within a desirable position relative to the field of view of the camera based on tolerance areas set by the creator of the camera vision program. FIG. 4 represents an overlay of the tolerance areas relative to an actual landing target.

FIG. 2 depicts an example landing process that allows the autonomous UAV to achieve a precision landing. Multiple zones can and should be incorporated for the most efficient landing process. Each “zone” or defined altitude aids in the decision-making process. In zones that are higher, relative to the landing target, horizontal tolerances need not be as refined as those of lower zones or heights. FIG. 2 depicts ZONE 1 as being the general area by which a UAV might autonomously arrive within the vicinity of the landing target due to the expected horizontal accuracy of a GNSS receiver. First, when the UAV confirms that the landing target is within the field of view anywhere while the UAV is in ZONE 1, the UAV may proceed to descend into ZONE 2. Next, while the UAV is in ZONE 2, the goal of the UAV is to move horizontally to until the landing target is approximately in the center of the camera or sensors field of view. Once the landing target is in a desirable location relative to the camera or sensor field of view, the UAV may descend to ZONE 3. If the UAV is detecting that the landing target is within the central area of the field of view and that a successful landing is imminent, it may descend into ZONE 4 (depending on the tolerance set by the operator), or attempt to land directly on the target. Alternatively, if the UAV enters ZONE 3 and calculates that the landing target is too far from the center of the camera/sensor field of view, the UAV may ascend and try to center itself more appropriately before descending back to ZONE 3. The example altitudes shown on FIG. 2 are for illustrative purposes; other altitudes may be set in the system for individualized configurations.

To fully achieve an efficient landing process, additional measures can be instilled in the landing protocol. Some of these can include one or more of the following characteristics.

1. Use an “inner” and “outer” tolerance area (as depicted in FIG. 4) and define which zones require that the landing target fall within the inner tolerance area before descending to the subsequent level. In FIG. 2, this could include requiring that even ZONE 1 requires a horizontal position that falls within the “outer tolerance box” before any descent movements. In FIG. 2, this could include requiring that ZONE 2 requires a horizontal position that falls within the “inner tolerance box” before any descent movements.

2. Avoid any camera or vision processing while in the lowest zone(s) due to possible reflection and erroneous values caused by illuminated target reflection on the camera or sensor lens. The ability to safely move horizontally might be limiting due to equipment on the ground or due to the adverse flight performance commonly observed while the aircraft is in “ground effect” (which is the aerodynamic performance change due to air flow between the aircraft and the surface below).

FIG. 3 illustrates the general process by which the horizontal movement commands (shown in FIG. 2) and the tolerance box acceptance ranges (shown in FIG. 4) are executed. Each vertical level is most likely determined by using the vehicle's barometer, GNSS altitude, or other distance sensor. Depending on the environmental conditions, UAV flight performance capabilities and camera or visual sensors, this process can be refined as the user sees fit. These factors among other parameters including landing pad size, airframe size and landing gear configuration might prompt a more precise landing, thus requiring the size of the inner and outer tolerance boxes to be modified. The smaller the boxes, the tighter the horizontal tolerance relative to the landing target. The process of ascending and re-searching based on either necessity or desire to achieve a precise horizontal position upon landing is an essential component of a high precision landing system.

In step S1, the UAV 100 arrives at an approximate landing location. In step S2, the UAV 100 may determine that the landing target is not in its field of view. In step S3, if the landing target in not in the UAV 101 field of view, the UAV ascends and searches again.

In step S4, the UAV 100 may determine that the landing target is in its field of view. In step S5, if the landing target is in the UAV 101 field of view, the UAV descends into the next zone (see FIG. 2).

In step S6, the UAV 100 may determine that the landing target is within inner tolerance box. In step S7, if the landing target is in the inner tolerance box, the UAV 101, the UAV 100 will attempt to land.

In Step S8, the UAV 100 may determine that landing target is within outer tolerance box. In Step S9, if the landing target is within the outer tolerance box, the UAV 101 will descend into the next lower zone.

In step S10, the UAV 100 may determine that landing target is not within the field of view. In step S11, if the landing target is not within the field of view, the UAV 100 may ascend and search again.

The steps in box A may continue and/or repeat based on environmental and technological parameters.

FIG. 4 represents the virtual tolerance boxes that may be used to determine acceptable area(s) of the landing target relative to the camera/sensor field of view. The outer box 400 represents the camera field of view, which can be, for example, 1920 pixels×1080 pixels. The tolerance boxes are defined into an outer tolerance area 402 and an inner tolerance area 403. An undesirable area 401 is defined outside of outer tolerance box 402.

A precision landing program might have one or several of these tolerance areas for the purposes of: commanding a more rapid descent when the landing target appears to be close to the center of the field of view (implying that the target is directly below the aircraft); commanding a more aggressive or lengthy horizontal movement based on the estimated position of the landing target within the field of view; commanding an ascent if the landing target is outside of the acceptable limits of any tolerance box. Tolerance box sizes might dynamically change based on the aircraft's altitude.

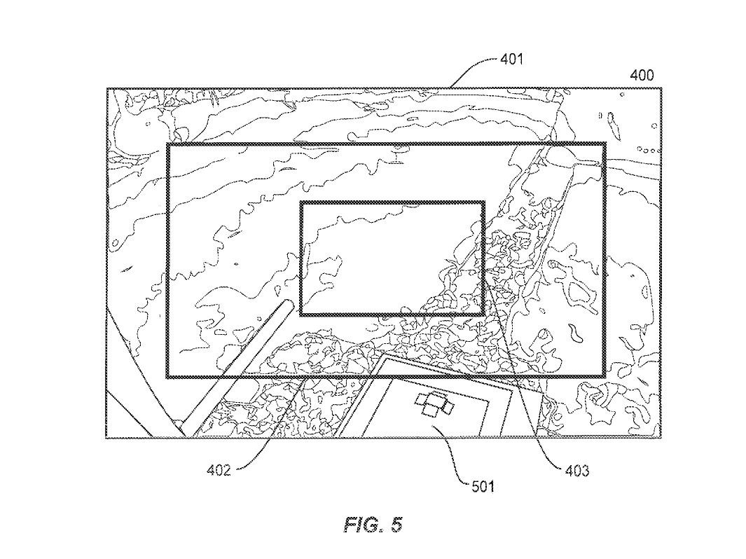

FIG. 5 depicts a camera sensors real-world view with a virtual tolerance box overlay. In this scenario, the camera vision program of the UAV 100 would calculate that the centroid (center value) of the landing target 501 is outside of both the inner and outer tolerance area and therefore the UAV 100 must be commanded to ascend and move horizontally in attempt to position itself so that the landing target centroid is within one of the acceptable tolerance boxes.

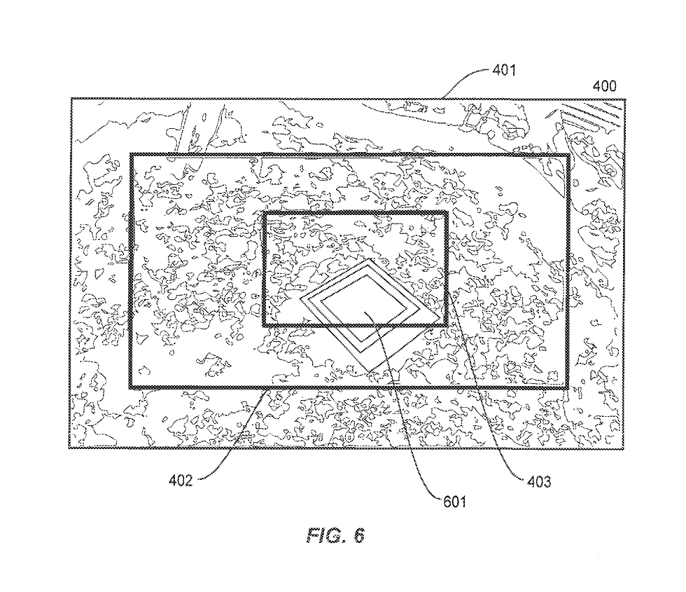

FIG. 6 on the other hand, depicts the centroid of the landing target 601 to be directly within the inner tolerance box. In this case, the UAV 100 should be commanded to land without the need to ascend and re-search for its target.

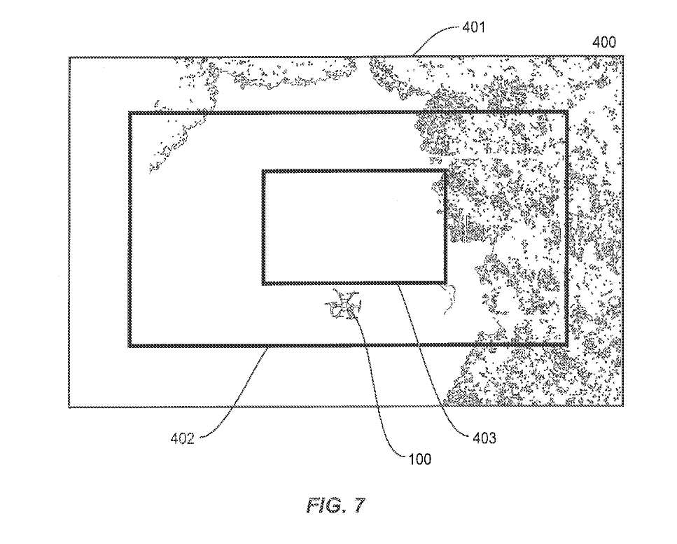

As shown in FIG. 7, the location of the target identification marker (optical or non-optical identifiers for example) and target identification equipment (sensor, imager, cameras, etc.) may be reversed for the purpose of process efficiency. While the previous statements describe a method whereby target identification, image processing and flight control movement commands are performed on the UAV, such identification and processing equipment may alternatively be installed on the ground station or intended landing target site. FIG. 7 provides a camera vision based example of acquiring the moving target (the UAV 100) and performing image capture, camera vision calculations and broadcasting movement commands back to the UAV 100 over a wireless connection which may be transmitted by methods including but not limited to Bluetooth, Wi-Fi, Zigbee, Xbee, or Radio Frequency. In this configuration the UAV 100 would be equipped with the target identification marker such as a thermal, optical or non-optical marker. The benefit for this configuration of the hardware is that the UAV 100 will not be required to carry and provide lift power for such heavier and more processing intensive computing hardware. For example, the UAV 100 will no longer be responsible for its own image capture (meaning no camera/imager or gimbal assembly is required), nor will it be responsible for its own data processing (example: no camera vision programs or processor intensive applications need to be run). The benefits of this configuration include the system on the UAV 100 focusing computing power only for simple commands which could improve latency of mission critical operations. Furthermore, smaller and lighter computing devices may be used to improve overall flight efficiency by reducing total aircraft weight and increasing operational flight time. In this configuration it can be observed that the ground station or landing area site is capable of utilizing heavier, more power consuming and more power computing capable hardware due to the lack of limitations otherwise associated with aircraft weight, balance, power and performance restrictions.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. An unmanned aerial vehicle (UAV) landing system, comprising:
memory;
an imaging device; and
a processor in communication with the memory and imaging device, wherein the processor is configured to:
acquire, via the imaging device, a landing target;
descend the UAV into a first zone associated with the landing target;
determine if the landing target is within a field of view; and
descend the UAV toward the landing target if the landing target is determined to be within the field of view.

2. The system of claim 1, wherein the processor is further configured to ascend the UAV out of the first zone if the landing target is not within the field of view.

3. The system of claim 1, wherein the processor is further configured to:
abort a landing if the landing target is not within the field of view; and
direct the UAV to reposition to reacquire the landing target.

4. The system of claim 1, wherein the imaging device is at least one of a visual spectrum camera and an infrared camera.

5. The system of claim 1, further comprising:
a landing target processor,
wherein the imaging device is position at or about the landing target, and the landing target processor is in communication with the UAV.

6. An unmanned aerial vehicle (UAV) landing system, comprising:
memory;
an imaging device; and
a processor in communication with the memory and imaging device, wherein the processor is configured to:
acquire via the imaging device a landing target;
descend the UAV into a first zone associated with the landing target;
determine if the landing target is within a field of view; and
descend the UAV toward a second zone associated with the landing target if the landing target is determined to be within the field of view.

7. The system of claim 6, wherein the second zone is nearer to the landing target than the first zone.

8. The system of claim 7, wherein the processor is further configured to:
determine if the landing target is within the field of view when positioned within the second zone; and
ascend the UAV into the first zone when the landing target is not within the field of view when the UAV is positioned within the second zone.

9. The system of claim 8, wherein the processor is further configured to descend the UAV to a third zone or the landing target when the landing target is determined to be within the field of view when the UAV is positioned within the second zone.

10. The system of claim 6, wherein the imaging device is at least one of a visual spectrum camera and an infrared camera.

11. The system of claim 6, further comprising:
a landing target processor,
wherein the imaging device is position at or about the landing target, and the landing target processor is in communication with the UAV.

12. An unmanned aerial vehicle (UAV) landing method, comprising:
acquiring, using a processor, a landing target;
descending the UAV, using the processor, into a first zone associated with the landing target;
determining, using the processor, if the landing target is within a field of view; and
descending the UAV, using the processor, toward a second zone associated with the landing target if the landing target is determined to be within the field of view.

13. The method of claim 12, wherein the second zone is nearer to the landing target than the first zone.

14. The method of claim 13, further comprising:
determining if the landing target is within the field of view when positioned within the second zone; and
ascending the UAV to the first zone when the landing target is not within the field of view when positioned within the second zone.

15. The method of claim 14, further comprising descending the UAV into a third zone or onto the landing target when the landing target is determined to be within the field of view when the UAV is positioned within the second zone.
